(19) United States
(12) Patent Application Publication
(10) Pub. No.: US 2021/0016875 A1
(43) Pub. Date: Jan. 21, 2021

(54) AIRSKI EVTOL PAV WITH INTEGRATED DUCTED-FAN FAIRING

(71) Applicant: Adam James Grabowski, Hampton, VA (US)

(72) Inventor: Adam James Grabowski, Hampton, VA (US)

(21) Appl. No.: 16/665,548

(22) Filed: Oct. 28, 2019

Related U.S. Application Data
(63) Continuation of application No. 62/876,717, filed on Jul. 21, 2019.

(51) Int. Cl. B64C 27/20; B64D 11/06; B64D 29/06; B64D 27/24; B64F 5/10; B64D 33/02; B64D 33/04; B64C 1/24; B64C 25/06; B64C 25/64; B64D 33/08

(52) U.S. Cl. CPC B64C 27/20; B64D 11/0619; B64D 11/064; B64D 29/06; B64D 27/24; B64F 5/10; B64C 39/001; B64D 33/04; B64C 1/24; B64C 25/06; B64C 25/64; B64D 33/08; B64D 11/0698; B64D 33/02

(57) ABSTRACT

An Electric Vertical Take-off and Landing (EVTOL) Passenger Air Vehicle (PAV) using a plurality of electric motors positioned concentrically about the passenger compartment and utilizing ducted turbines to produce thrust allowing the vehicle to take off and land vertically and fly without the use of aerodynamic wings. Utilizes a plurality of independent electric battery powered motors providing sufficient thrust to ensure the vehicle can hover and complete a safe landing despite a loss of thrust from any two adjacent motors and up to half of the motors, if non-adjacent, by utilizing redundant onboard flight control systems to vary motor torque as need to maintain steady, controlled flight. Design utilizes a pivoting seat for passenger comfort as well as shock mounting of the seat for safety. Ingress and egress are facilitated by integrated folding air stairs. The turbine fairing is designed to be rapidly manufactured as two parts, as upper and lower shells, using a composite forging process.

### CROSS-REFERENCE TO RELATED APPLICATION

This application is a continuation of provisional application No. 62/876,717 filed 21 Jul. 2019.

### FEDERALLY SPONSORED RESEARCH

None

### SEQUENCE LISTING

None

### TECHNICAL FIELD

The present invention relates to electric powered passenger aviation.

### REFERENCE U.S. PATENT DOCUMENTS

U.S. Ser. No. 323,269 November 1981 Andresevitz
U.S. Pat. No. 6,179,247 Juy 1999 Milde
U.S. Pat. No. 6,568,630 August 2001 Yoeli
U.S. Pat. No. 6,886,776 September 2002 Wagner
U.S. Pat. No. 7,686,579 August 2006 Ishiba
U.S. Pat. No. 9,096,314 March 2010 Brotherton-Ratcliffe
U.S. Pat. No. 9,944,389 March 2017 Piasecki Aircraft Corporation
U.S. Pat. No. 10,272,995 May 2016 SkyKar Inc.

### TECHNICAL FIELD

This invention relates to the field of aerial vehicles in general and the field of electrically powered aerial vehicles in particular.

### BACKGROUND OF THE INVENTION

The advent of the EVTOL PAV seems to have arrived with major aviation and transportation industry players getting serious about “flying cars”. This new movement is labeled as Urban Air Mobility (UAM) and there is a major push to bring the concept to reality in the near future. The EVTOL PAV is an improvement over helicopter design and function due the simpler design, low number of moving parts, and much lower maintenance requirements; as well as improved safety. Safety is enhanced through redundancy of multiple independent batteries motors and turbines.

Beyond mechanical differences from conventional winged aircraft, EVTOL PAV's will predominantly be autonomous vehicles. There are several advantages to this such as no flight training being required to operate the vehicle; also, since no pilot is needed, the vehicles can be single occupant commuting vehicles of relatively small size and weight. This small size will allow them to land in very small areas that would never accommodate a conventional helicopter to safely land. This represents the biggest advantage of the EVTOL PAV, the ability for controlled landings in congested urban areas without the need for extensive infrastructure improvements, thus facilitating air travel for the masses on a daily basis.

### SUMMARY OF THE INVENTION

The principal object of the present invention is an UAM PAV that is electrically powered, provides EVTOL capability, is lightweight, inexpensive to construct compared to winged aircraft, and safer to fly and land in populated areas than a conventional helicopter. In addition, the present invention provides a unique ducted turbine fairing configuration for safety, increased thrust, improved aerodynamics, and decreased noise levels. Performance and safety are enhanced by a design that provides a minimum 2:1 thrust to weight ratio allowing high performance and a high factor of safety to include safe emergency landing capability in the event of multiple thrust device failures.

In designing this EVTOL PAV certain design assumptions have been made:
1. The vehicle is designed to carry one passenger, in the current configuration, or pilot if certified, but could be enlarged with a greater multitude of motors and turbines to accommodate plurality of passengers.
2. The vehicle is capable of vertical take-off and landing.
3. For increased safety the vehicle is capable of flying with an inoperable motor and can safely land with up to four inoperable motors depending on the orientation of operable to inoperable motors in relation to the center of gravity of the vehicle and center of lift created by operating motors.
4. The wingless PAV is designed to be made from a forged carbon fiber manufacturing technology or other similar methods. The turbine fairing can be stamped or forged in respective top and bottom halves making manufacturing extremely time efficient compared to more conventional composite layup techniques.
5. Ingress and egress are facilitated by the tilting canopy and folding double-hinged air stairs design, allowing a passenger to safely and easily board the PAV with their belongings.
6. With current lithium ion battery technology and the restraint of keeping weight limited to approximately 2000 pounds the estimated flight time of the PAV is 20-30 minutes. As battery technology advances this flight time can be extended, or vehicle weight reduced providing greater efficiency.

### DRAWINGS—FIGURES

FIG. 1 shows the front and left side quarter view showing the basic PAV design layout.

FIG. 2 shows the bottom rear view.

FIG. 3 shows front view with dome canopy and stairs in the open position, the pivoting seat can be seen inside.

FIG. 4 shows side view with dome canopy and stairs in the open position.

FIG. 5 shows the bottom half of the turbine fairing shell.

FIG. 6 shows the top half of the turbine fairing shell.

FIG. 7 shows passenger seat, right side view.

FIG. 7a shows passenger seat suspension detail view

FIG. 8 shows PAV in forward flight configuration, the dome canopy is not show in this view to allow a clear view of the battery configuration.

FIG. 9 shows PAV is a narrow canopy configuration that allows air cooling of the batter compartment.

### DRAWINGS—REFERENCE NUMERALS

11 stairs

12 domed canopy

13 turbine rotors

14 ducted rotor exhaust nozzles

15 turbine fairing

16 seat suspension

17 self-leveling seat

18 double hinged air stairs hinge panel

19 multifunction displays

20 manufacturing seam

21 passenger compartment/electronics compartment wall

22 batteries and various electrical equipment

23 motor (1 of 8)

24 landing feet

25 swirl straighteners

26 narrow canopy

27 air flow, battery cooling

### DETAILED DESCRIPTION OF THE PREFERRED EMBODIMENTS

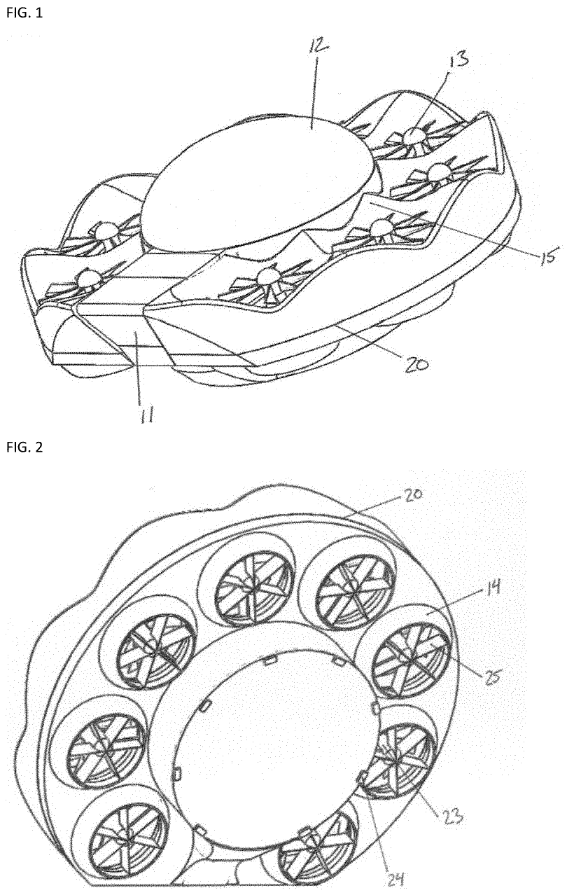

FIG. 1 is a perspective, in flight, view of the EVTOL PAV. This present invention utilizes eight motors each coupled to an air turbine 13 mounted within the integrated 8-motor-fairing 15 in an octocopter configuration. The front of the PAV features fold-away passenger air-stairs 11 that when closed, along with the dome canopy 12, become part of the aerodynamic fuselage. The entire top of the vehicle is designed to reduce aerodynamic drag by smoothing airflow through the engines and creating a low-pressure area above the vehicle. The ducted turbine fairing arrangement also reduces rotor noise and greatly enhances safety of bystanders and passengers by enclosing all dangerous moving parts.

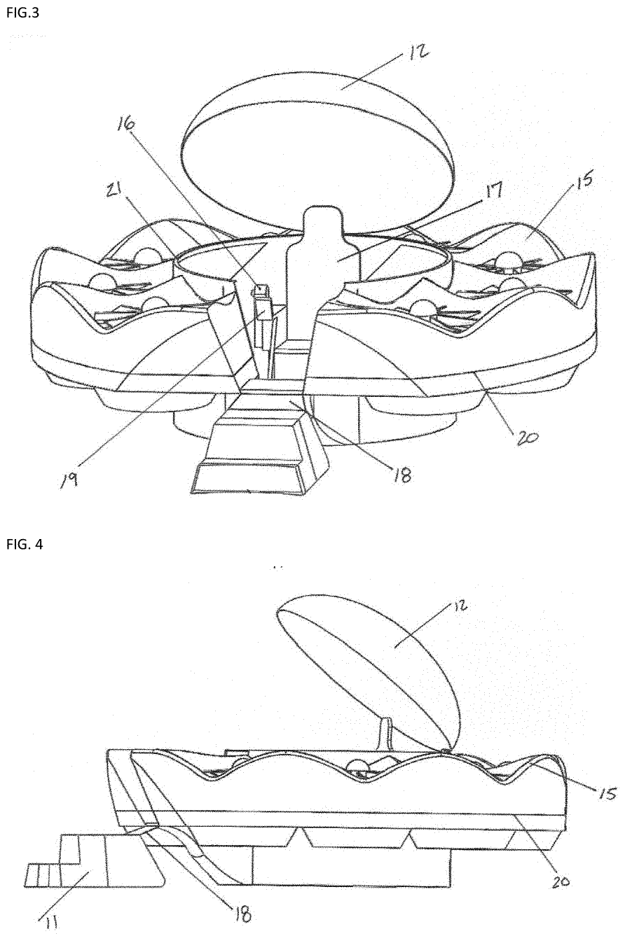

FIG. 2 is the bottom aft view showing the ducted fan exhaust ports 14, and motors 23 with attached swirl straighteners 25. Various landing gear apparatus could be added to the bottom of the PAV to include simple rubber feet 24 or small leaf springs to protect the underside of the vehicle when landing on uneven or rough ground.

FIG. 3 is the front view with the parabolic domed canopy 12, in the open position, which can utilize a reflective coating to minimize heat buildup in occupant cabin. The passenger air-stairs are also shown in the open position. In this view the self-leveling seat 17 is visible with the PAV information and navigation display 19 shown on right hand side and duplicated on left hand side of the seat assembly. The passenger seat is mounted to the interior walls by a pivot pin 16 on each side, coupled to wall fittings. The seat is spring, and damper supported to provide shock absorption for the passenger or pilot in the event of a hard landing.

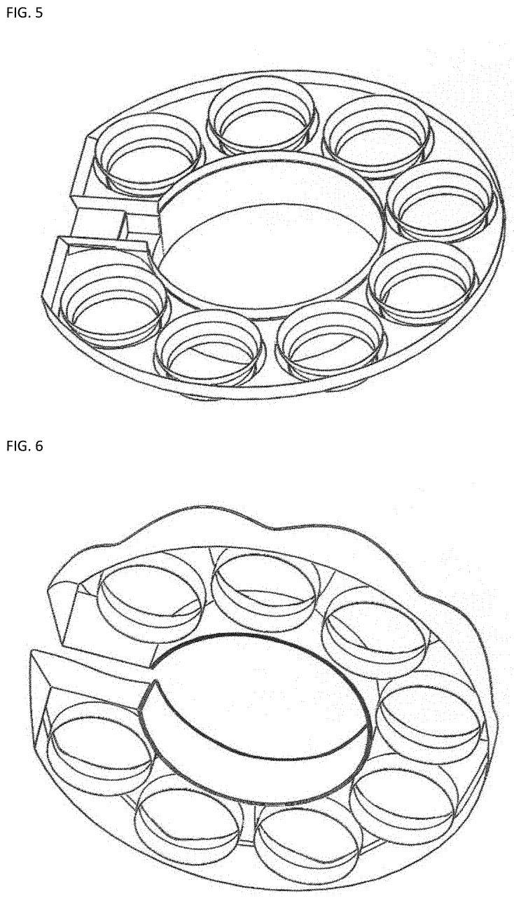

FIG. 4 is a front quarter view showing the air-stairs assembly 11 which folds out from the turbine fairing assembly 15 on a double hinged panel 18 allowing the stairs to rest flush the ground regardless of relative ground to vehicle angle.

FIG. 5 and FIG. 6 show an exploded view of the PAV bottom and top motor fairing halves, respectively. The two haves are intended to be bonded together to form the turbine fairing of the PAV.

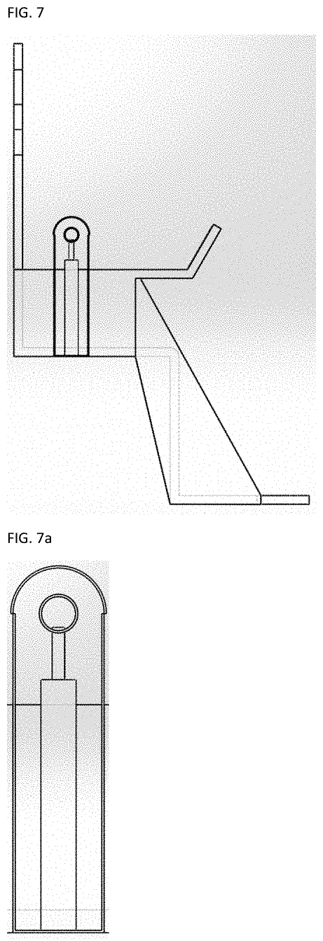

FIG. 7 is a side view of the self-leveling passenger seat with integrated shock absorbing suspension system.

FIG. 7a is a detail view of the passenger seat shock absorbing suspension system.

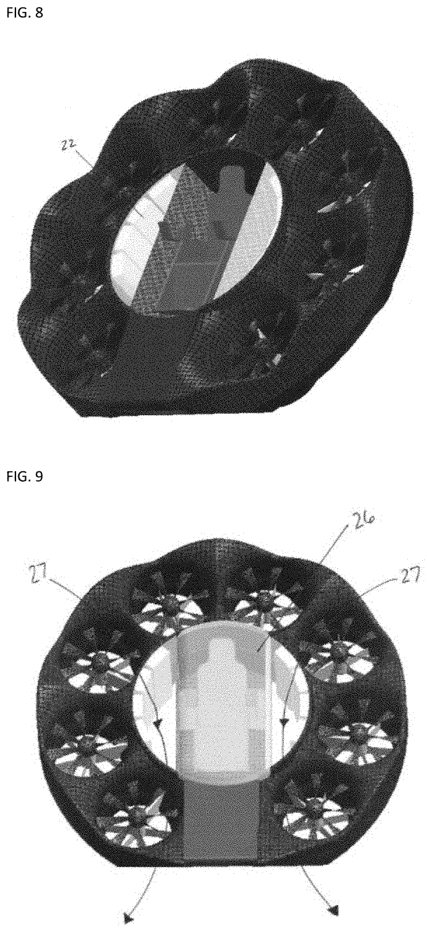

FIG. 8 shows the PAV in forward flight configuration at a high angle of attack to illustrate the operation of the self-leveling seat system which keeps the passenger level at all forward flight angles for greater comfort and visibility. Also shown are the independent batteries 22 in an isolated electronics compartment on each side of the passenger compartment. The batteries and associated electronics are sealed from the passenger compartment for safety. There is a separate battery 22 pack to power each individual motor to enhance vehicle safety by employing multiple redundant propulsion and control systems. The battery packs are arranged to minimize wiring run lengths to each motor to reduce vehicle weight while keeping the center of gravity inboard to reduce mass moment of inertia and maximize vehicle maneuverability.

FIG. 9 shows an alternate embodiment of the present invention utilizing a narrow occupant canopy design and open floor sections thereby allowing cooling air to the PAV batteries and electrical compartments.

I claim:

1. A passenger seat utilized in the present invention that is allowed to tilt on the PAV transverse axis by means of mounting pins supported by the adjacent wall structure to either side, thereby enabling said seat and PAV passenger to remain at an approximately level attitude during all phases of flight.
a. The passenger seat of claim 1 wherein self-leveling is achieved by attaching the seat to the PAV by means of a pivot pin and is balanced by the geometric positioning of said pivot pin in relation to said passenger and seat combined center of gravity.
b. The passenger seat of claim 1 wherein the seat angle relative to the PAV floor may be adjustable by means of changing the position of the mounting pins relative to the occupant center of gravity through an unspecified mechanism of forward and aft seat-mount position-adjustment.
c. The passenger seat of claim 1 wherein safety is enhanced by a shock absorbing system built into said seat mount arms that allow substantial hard landing energy to be absorbed by said seat mount, reducing the possibility of passenger injury.

2. A design for EVTOL multiple turbine fairing which integrates air-stairs for passenger ingress, egress which extend from and retract into the turbine fairing by means of a double hinge thereby allowing the adjacent fairing upper edge to become a handhold whereby substantially easing passenger ingress and egress.
a. The passenger air-stairs of claim 2 wherein utilizing a double hinge design provides means for said air-stair assembly to rest flush on the ground when open even if the surface is not on the same plane which the PAV is resting.

3. A manufacture process, utilized by the present invention, of a composite material forging utilizing materials such as carbon fiber to produce the vehicle in a plurality of parts such as top and bottom shells which when bonded together produce an integrated multiple-turbine fairing, exhaust nozzle, inner stairs and passenger compartment as a single unit whereby substantially increasing manufacturing efficiency.
a. The turbine fairing of claim 3 wherein by means of the flared turbine-intake tract, aerodynamic drag is reduced by the action of the rotation turbines.
b. The turbine fairing of claim 3 wherein utilizes landing gear containing a device selected from the group consisting of a multitude of rubber feet and unspecified mounting hardware to be mounted about the outer edge of the bottom of the PAV whereby protecting the PAV from foreign object damage upon landing.

4. A fairing design of an alternate embodiment FIG. 9, which allows convection air cooling of electrical components of the present invention by means of direct airflow through said electronics compartment of said fairing during forward flight.
a. The fairing design of claim 4 wherein provides motor cooling by means of conduction through the motor mount being constructed of an unspecified material of high thermal conductivity thereby providing means for convection cooling of said motor by the induced airflow about the mount positioned below the air turbine.
